(19) United States
(12) Patent Application Publication
(10) Pub. No.: US 2023/0166306 A1
(43) Pub. Date: Jun. 1, 2023

(54) CAGE CLEANING DEVICE

(71) Applicant: Haarslev Industries A/S, Søndersø (DK)

(72) Inventors: Anders SVEHAG, Søndersø (DK); Bjarne GRØNBECH, Søndersø (DK); Thoke Sandager THAYSEN, Søndersø (DK)

(21) Appl. No.: 18/070,207

(22) Filed: Nov. 28, 2022

(30) Foreign Application Priority Data
Nov. 29, 2021 (DK) PA 2021 01130

(51) Int. Cl. B08B 9/043; B65G 45/00

(52) U.S. Cl. CPC B08B 9/0436; B65G 45/005; B30B 9/14

(57) ABSTRACT

The present invention relates to a cleaning device comprising at least two corpus elements, the corpus element comprises two interconnected side surfaces, the two interconnected side surfaces comprise a cleaning part and a connecting part for connecting the at least two corpus elements, wherein the cleaning part comprises a curved structure extending from a first-side to a second-side of the cleaning part.

### TECHNICAL FIELD OF THE INVENTION

The present invention relates to an improved screw press. In particular the present invention relates to an improved screw press where cleaning and handling of the cage are improved and access to the inlays, press chamber and the screw are improved resulting in a high durability of the screw press and a maintained high productivity.

### BACKGROUND OF THE INVENTION

It may be desirably to remove or extract fats and oils from products, such as from cooked and dried animal and poultry by-products, either because the fats and oils may have a negative effect on taste, stability, appearance of a food or feed product, or extraction of the fat or oil may have a desired nutritional value.

The extracted oils and fats may be used as a nutritional ingredient, as a constituent a non-consumable product, or e.g. in a biofuel product. Therefore, the production of high value fat or oil products may be of high interest.

Fats are considered triglycerides that are solid or semi-solid at room temperature, whereas oils are also triglycerides, however, triglycerides that are liquid or clear liquid at room temperature. The fats comprise mainly saturated fatty acids whereas as the oils mainly comprises monosaturated or polyunsaturated fatty acid.

Extraction of the fats or oils may be mechanically or chemically, however, mechanically process may be preferred since the mechanical process are faster, simpler and cheaper. Furthermore, the mechanical process does not have chemical influence on the final fat product or oil product that also needs to be considered or handled.

Mechanical extraction of fats or oils may include a screw press comprising a screw and a cage. The screw comprises a helical structure surrounding a rotating shaft. The screw is surrounded by a cage comprising a perforated housing allowing the fat or oil to leave the material to be pressed through spaces between inlays and then collected.

DE 4238730 describes a cleaning device for cleaning the worm shaft of a screw press between the helical structure. The cleaning device comprising a corpus element where the corpus element comprises a cleaning part and the cleaning part comprises a curved structure extending from a first side to a second side of the cleaning part. During rotation of the worm shaft, the cleaning device is compulsorily conveyed upward or downward along the worm shaft, depending on the direction of rotation. When the cleaning device reaches the end of the worm, the rotation direction of the worm shaft is changed, and the cleaning device may be moving the other direction. The challenge with these devices is that they do not clean the outer side of the cage of the screw press, i.e. the outside of the inlays.

During operation of the screw press, a starting material to be pressed may be separated into a fat part (or an oil part) and a solid material. The fat part (or the oil part) may be separated from the solid part through spaces between inlays placed on the inside of the cage and via the perforated housing of the cage and into a collection device. Over time the spaces between the inlays may become dirty since the fat part (or the oil part) in combination with fines of the residual part, may block or obstruct space and the sides of the inlays causing productivity and efficiency of the screw press to be reduced and maintenance and/or cleaning may be necessary. This maintenance and/or cleaning are difficult to perform and involves downtime of the screw press and disintegration of several parts of the screw press and the cage before the complicated cleaning procedure and/or maintenance procedure can be performed.

Hence, there is a need in the industry for an improved screw press, in particular a fat screw press, for an improved screw press where cleaning of the perforated housing of the cage of the screw press is easy and quickly, resulting in an improved productivity and efficiency of the screw press and wherein downtime of the screw press may be significantly reduced.

### SUMMARY OF THE INVENTION

Thus, an object of the present invention relates to an improved screw press where cleaning and/or handling of the cage are improved and access to the inlays, press chamber and the screw are improved resulting in a high durability of the screw press and a maintained high productivity.

In particular, it is an object of the present invention to provide a screw press that solves the above mentioned problems of the prior art with difficulties and time consuming cleaning and/or handling of the cage, long downtime of the screw press with low productivity and low efficiency.

Thus, one aspect of the invention relates to a cleaning device comprising at least two corpus element, the corpus element comprises two interconnected side surfaces, the two interconnected side surfaces comprise a cleaning part and a connecting part for connecting the at least two corpus elements, wherein the cleaning part comprises a curved structure extending from a first-side to a second-side of the cleaning part.

Another aspect of the present invention relates to a cage, for a screw press, comprising a cleaning device according to the present invention wherein the cleaning device may be fixed to the cage.

Yet another aspect of the present invention relates to a screw press comprising a press chamber comprising a screw and surrounded by a cage, wherein the screw comprising a shaft having a helical structure on the outside of the shaft, and wherein the cage is provided with at least two cage elements, the cage is provided with a cleaning device according to the present invention.

Still another aspect of the present invention relates to the use of the cleaning device according to the present invention, as a cage cleaning device for removing solid material from the surface of a cage of a screw press.

In a further aspect of the invention relates to a screw press comprising a press chamber comprising a screw and surrounded by a cage, wherein the screw comprising a shaft having a helical structure on the outside of the shaft, and wherein the cage is provided with at least two cage elements, wherein at least one cage element of the at least two cage elements comprises a pivotable connection allowing the at least one cage element to pivot, wherein a screw press is provided with a cage open assistant, assisting the at least one cage element to pivot.

Yet an aspect of the present invention relates to a screw press comprising a press chamber comprising a screw and surrounded by a cage, wherein the screw comprising a shaft having a helical structure on the outside of the shaft, and wherein the cage is provided with at least two cage elements, wherein at least one cage element of the at least two cage elements comprises a pivotable connection allowing the at least one cage element to pivot, wherein a screw press is provided with at least 2 beams centrally placed above the press chamber.

Another aspect of the present invention relates to the use of the screw press according to the present invention, for the separation of a liquid from a solid of a starting material.

Yet another aspect of the present invention relates to a method of inspecting the screw press according to the present invention, the method comprising the steps of:

(i) removing a first cassis side;

(ii) attaching a first fastening means of a cage open assistant to a second fastening means of a cage element;

(iii) activating the cage open assistant opening the cage element providing access to a press chamber and a screw of the screw press;

(iv) subjecting the cage to the required maintenance; and

(v) activating the cage open assistant and closing the cage element.

(vi) optionally, repeating steps (i)-(v) with a further cage element.

### BRIEF DESCRIPTION OF THE FIGURES

FIG. 1 shows a screw press according to the present invention,

FIG. 2 shows the screw press as demonstrated in FIG. 1, where part of the chassis surrounding the screw press has been removed to show the inside of the screw press and a supporting device for stabilizing the screw press,

FIG. 3 shows the cage element of the screw press demonstrated in FIG. 1 and FIG. 2, and where the inlays are placed on the inside of the cage elements,

FIG. 4 shows a more open view of the cage demonstrated in FIG. 3,

FIG. 5 shows the cage open assistant as according to the present invention integrated into the supporting device of the screw press as demonstrated in FIG. 1 or FIG. 2 and attached to the beams (comprising two beams placed centrally over the press centre) of the supporting device,

FIG. 6 shows a screw press as demonstrated in FIG. 1 and FIG. 2, with an open cage element demonstrating the cage open assistant as integrated into the screw press and attached to the beams (comprising two beams placed centrally over the press centre) of the supporting device,

FIG. 7 shows a side-view of the screw press as demonstrated in FIG. 1 and FIG. 2 with an open cage element using a cage open assistant as according to the present invention integrated into the screw press and attached to the beams (comprising two beams placed centrally over the press centre) of the supporting device,

FIG. 8 shows the cleaning device, the cage cleaning device, according to the present invention, and

FIG. 9 shows a screw press comprising a cage comprising two cage elements and wherein the cleaning device according to the present invention is attached to the cage elements.

The present invention will now be described in more detail in the following.

### DETAILED DESCRIPTION OF THE INVENTION

Accordingly, the inventors of the present invention found that the conventional methods of cleaning the cage by opening the cage elements followed by removing solidified fines and liquids, e.g. fats/oils, was too complicated, time consuming and expensive and a new solution is necessary.

Thus, a preferred embodiment of the present invention relates to a cleaning device comprising at least two corpus element, the corpus element comprises two interconnected side surfaces, the two interconnected side surfaces comprise a cleaning part and a connecting part for connecting the at least two corpus elements, wherein the cleaning part comprises a curved structure extending from a first-side to a second-side of the cleaning part.

The two interconnected side surfaces may be provided to stabilize the corpus elements. The two interconnected side surfaces may comprise a solid plate or a lattice.

Preferably, the two interconnected side surfaces are made by a metal material, a ceramic material, or a plastic material.

In an embodiment of the present invention the corpus element may be made by a metal material, a ceramic material, or a plastic material.

Preferably, the metal material may be carbon steel or stainless steel. In particular, the metal material may be stainless steel.

In an embodiment of the present invention the space between the two interconnected side surfaces is an open space.

The open space between the two interconnected side surfaces may be provided to allow material cleaned from the e.g. the cage of the screw press to escape from the cage and the cage cleaning device.

The two interconnected side surfaces of the corpus element may be combined at the connecting part and at the first side of the cleaning part and at the second part of the cleaning part.

In an embodiment of the present invention the cleaning part comprises a cutting element.

In a further embodiment of the present invention the cleaning part comprises a scraping element.

In yet an embodiment of the present invention the cleaning part comprises a cutting element and a scraping element.

The first side of the cleaning part may be provided with a cutting element and the second side of the cleaning part may be provided with a scraping element, or vice versa.

The cutting element and/or the scraping element may be provided at the ends (e.g. at the first part and/or at the second part) of the cleaning part.

The curved structure of the cleaning part may be configured to engage closely with the outside part of the inlays placed inside the cage of the screw press.

When moving the cleaning device according to the present invention the cutting element and/or the scraping element may be moving across/transversely over the inlays and the cutting element may be cutting off the solid content from the out-side of the inlays.

This cleaning of the inlays improves the performance and efficiency of the screw press as well as durability of the of the inlays may be improved.

In an embodiment of the present invention the cutting element may be provided from a metal material or a ceramic material. Preferably, the metal material may be provided from steel material, preferably stainless steel.

In a further embodiment of the present invention the sliding element (38) may be provided from a polymeric material. The polymeric material may be selected from a plastic material or a rubber material.

The cutting element may be separated from the scraping element by the curved structure.

The width of the cutting element may be the same, or substantially the same, as the width of the scraping element.

Preferable, the length of the curved structure may be longer than the width the of the cutting element and/or the width of the scraping element.

In an embodiment of the present invention the width of the cutting element and/or the width of the scraping element for the particular application of the cleaning device. Thus, when the cleaning device may be used as a cage cleaning device for cleaning the outer surface of inlays of a cage of a screw press, the width of the cutting element and/or the width of the scraping element may be configured to the fit into the elongated holes between the ribs of a cage of a screw press.

Preferably, the width of the cutting element and/or the width of the scraping element may be in the range of 0.1-40 cm, such as in the range of 0.5-30 cm, e.g. in the range of 0.75-25 cm, such as in the range of 1-20 cm, e.g. in the range of 2-15 cm, such as in the range of 3-10 cm, e.g. in the range of 4-8 cm, such as 5-7 cm.

In an embodiment of the present invention, the corpus elements may be provided with at least one supporting member extending from the curved structure and into an open space between the two interconnected side surfaces. The supporting member may be provided to strengthen and stabilize the individual corpus elements during use.

In a further embodiment the cleaning device of the present invention may be provided with at least two sliding elements. The at least two sliding elements may be movable connected with at least at least two sliding rails provided on the cage.

The cleaning device according to the present invention may comprise at least one corpus elements. Preferably, the cleaning device comprises several corpus elements.

In an embodiment of the present invention the cleaning device comprises at least 2 corpus elements, such as at least 4 corpus elements, e.g. at least 6 corpus elements, such as at least 10 corpus elements, e.g. at least 12 corpus elements, such as at least 14 corpus elements, e.g. at least 16 corpus elements, such as at least 18 corpus elements, e.g. at least 20 corpus elements, such as at least 22 corpus elements, e.g. at least 24 corpus elements, e.g. in the range of 2-25 corpus elements, such as in the range of 4-20 corpus elements, e.g. in the range of 6-15 corpus elements, such as in the range of 8-10 corpus elements.

The number of corpus elements may be dependent on the application of the cleaning device.

In a screw press the pressure on the starting material inside the press chamber increases as the starting material moves from the starting material through the press chamber to the outlet of solid material. This increased pressure may result in an increased amounts of e.g. fines of solids from the starting material to be squeezed out of the press chamber between the inlays together with the liquid separated from the starting material.

In an embodiment of the present invention the cleaning device according to the present invention may preferably be configured to cover only part of the elongated holes of the cage.

In a further embodiment of the present invention the cleaning device may be configured as a cage cleaning device for cleaning the outside of the inlays of the cage of the screw press.

Preferably, the cleaning device according to the present invention may comprise a number of corpus elements configured to comprise the same number of elongated holes provided in the cage or part of the elongated holes; such as at most 90% of the elongated holes, e.g. at most 80% of the elongated holes; such as at most 70% of the elongated holes, e.g. at most 60% of the elongated holes; such as at most 50% of the elongated holes, e.g. at most 40% of the elongated holes; such as at most 30% of the elongated holes, e.g. at most 25%% of the elongated holes.

In the event the cleaning device or the corpus elements are configured to only covering part of the elongated holes of the cage of a screw press, the cleaning device may preferably be installed at the end of the cage opposite to the starting material inlet. This configuration of the cleaning device relative to the starting material inlet may be preferred since the pressure at the distal end of the cage may be higher than at the starting material inlet.

The cleaning device according to the present invention may comprise a drive arm passing through the connecting part of each of the corpus elements present in the cleaning device. At the end of the drive arm (preferably at both ends of the drive arm), sliding elements are provided to control the movement of the cleaning device when operated.

In an embodiment of the present invention the drive arm may have a shape (from a cross-sectional view, which is different from circular to assist movement and cleaning. Thus, preferably, the shape of the drive arm may be triangular shaped, rectangular shaped, pentangular shaped, hexagonally shaped or the like to assist movement cleaning. The skilled person would now other relevant cross-sectional shapes of the drive arm for providing a firm fit with the corpus elements and avoiding sliding around the drive arm.A preferred embodiment of the present invention relates to a cage, for a screw press, comprising a cleaning device according to the present invention wherein the cleaning device may be fixed to the cage.

Preferably, the cage comprises two cage elements (a first cage element and a second cage element). In an embodiment of the present invention, both the first cage element and the second cage element may be provided with a cleaning device according to the present invention.

A preferred embodiment of the present invention relates to a screw press comprising a press chamber comprising a screw and surrounded by a cage, wherein the screw comprising a shaft having a helical structure on the outside of the shaft, and wherein the cage is provided with at least two cage elements, the cage is provided with a cleaning device according to the present invention.

In an embodiment the cleaning device according to the present may be a cage cleaning device. Preferably a cage cleaning device for a screw press.

In the context of the present invention the cage cleaning device may be a device configured to clean the outside of the inlays through the longitudinal holes provide between the ribs of the cage.

In an embodiment the cleaning device according to the present invention may be fixed to the cage by at least two sliding rails which are movable connected with sliding elements of the cleaning device according to the present invention.

In yet an embodiment of the present invention movement of the cleaning device may be controlled by an actuator.

Preferably, the movement of the cleaning device may be controlled by the actuator in combination with one or more sliding rails. The actuator may be providing the actual energy for initiating the movement and the sliding rails may be guiding the direction of the movement initiated by the actuator.

The sliding rails may comprise an elongated slot in which the sliding elements of the cleaning device according to the present invention may move along the path of the slot.

The sliding rails may also ensure close contact between the outside of the inlays and the curved structure (and the cutting part and the scarping part) of the corpus elements.

In an embodiment of the present invention the screw press may be provided with at least one actuator. The at least one actuator may have a stationary end, preferably the stationary end may be attached to the supporting device, and a movable end, preferably the movable end may be attached to the cleaning device according to the present invention.

In an embodiment of the present invention the stationary end of the actuator may be rotatable attached to the supporting device. By being rotatable attached to the supporting device, the actuator may be changed from a position towards to cage and/or the cleaning device, to a position parallel to, or substantially parallel to, the cage.

The advantage of providing the stationary end of the actuator rotatable attached to the supporting device, may be that handling during maintenance and opening of the cage easy, simple and fast, since the cleaning device only needs to be dismounted at the contact between the movable end and the cleaning device.

The actuator may have a lifetime of at least 1 month, such as at least 3 months, e.g. at least 6 months, such as at least 9 months, e.g. at least 12 months, such as at least 18 months, e.g. at least 24 months, such as at least 30 months, e.g. at least 36 months.

Preferably, the lifetime of at least 1 month, such as at least 3 months, e.g. at least 6 months, such as at least 9 months, e.g. at least 12 months, such as at least 18 months, e.g. at least 24 months, such as at least 30 months, e.g. at least 36 months may be achieved despite the actuator may be working at temperatures above 25° C., e.g. above 50° C., such as above 75° C., e.g. above 90° C., such as above 95° C., e.g. about 100° C.

The cage may be provided with the cleaning device according to the present invention allowing automatic cleaning of the inlays and the cage.

The movement of the cleaning device of the present invention, in particular when installed with a cage in a screw press, may be controlled according to different cleaning programs.

In an embodiment of the present invention the movement of the cleaning device of the present invention, when installed with a cage in a screw press, may be controlled to move constantly or at certain time intervals. Preferably, the movement of the cleaning device of the present invention, when installed with a cage in a screw press, may be controlled to move at certain time intervals.

Activation of the cage cleaning device, followed by the movement of the cage cleaning device along the outer surface of the inlays removing, or partly removing, material on the outer surface of the inlays, in particular solid material, until inactivation of the cage cleaning device may be a cleaning circle.

Preferably, the time interval between cleaning circles may be in the range of 5 minutes to 24 hours, such as in the range of 10 minutes to 20 hours, e.g. in the range of 15 minutes to 10 hours, such as in the range of 20 minutes to 5 hours, e.g. in the range of 25 minutes to 1 hours, such as in the range of 30 minutes to 45 minutes.

Preferably, the duration of a cleaning circle may be less than 20 minutes per cleaning circle, such as less than 15 minutes per cleaning circle, e.g. less than 10 minutes per cleaning circle, such as less than 5 minutes per cleaning circle, e.g. less than 2 minutes per cleaning circle.

In an embodiment of the present invention, the cage, in particular the at least one cage element of the at least two cage elements, may comprise a pivotable connection allowing the at least one cage element to pivot.

In a further embodiment of the present invention, the screw press may be provided with a cage open assistant, assisting the at least one cage element to pivot.

Preferably, the cleaning device according to the present invention may comprise at least two sliding elements, which at least two sliding elements may be movable connected with at least at least two sliding rails provided on the cage.

Preferably, the cleaning device according to the present invention may be integrated into the screw press, in particular in the chassis of the screw press.

By being integrated in the chassis of the screw press means that the cleaning device according to the present invention may be placed inside the chassis of the screw press and is not limited to being part of the chassis of the screw press.

In an embodiment of the present invention the actuator and/or the at least two sliding rails may be integrated in the chassis of the screw press together with the cleaning device according to the present invention.

A preferred embodiment of the present invention relates to the use of the cleaning device according to the present invention, as a cage cleaning device for removing solid material from the surface of a cage of a screw press.

The inventors of the present invention also found that the conventional methods of opening the cage elements, by building an external cage open assistant which is removed after maintenance, was too complicated, time consuming and expensive and a new solution is necessary.

Thus, A preferred embodiment of the present invention may relate to a screw press comprising a press chamber comprising a screw and surrounded by a cage, wherein the screw comprising a shaft having a helical structure on the outside of the shaft, and wherein the cage is provided with at least two cage elements, wherein at least one cage element of the at least two cage elements comprises a pivotable connection allowing the at least one cage element to pivot, wherein a screw press is provided with a cage open assistant, assisting the at least one cage element to pivot.

Another preferred embodiment of the present invention relates to a screw press comprising a press chamber comprising a screw and surrounded by a cage, wherein the screw comprising a shaft having a helical structure on the outside of the shaft, and wherein the cage comprises two cage elements, wherein at least one cage element, preferably both of the two cage elements, comprises a pivotable connection allowing the at least one cage element, preferably the two cage elements, to pivot, wherein a screw press is provided with a cage open assistant, assisting the at least one cage element, preferably both of the two cage elements, to pivot.

Preferably, the two cage elements may be sequentially subjected to pivot. Thus, the first cage element may be opened, and when the first cage element has been closed again, the second cage element may be opened.

Alternatively, the sequentially opening of the cage elements may involve pivoting the first cage element to open the first cage element, followed by pivoting the second cage element to open the second cage element. When the cage elements are opened, maintenance, repairing or substitution of worn parts may be performed and then the first cage element and the second cage element may be closed again.

In a preferred embodiment of the present invention the cage open assistant may be used for opening both the first cage element and subsequently the second cage element, or vice versa.

Preferably, the cage comprises two cage elements.

In an embodiment of the present invention the two cage elements comprise two semi-cylindrical cage elements.

The term “cage” relates to a cage-like structure or framework in a screw press allowing liquids and/or small solids of a material to pass whereas larger solids are prevented from passing the cage-line framework.

In an embodiment of the present invention the cage may preferably be provided with 2 cage elements. The number of cage elements may be determined by the number of cage elements from a cross-sectional perspective of the screw press perpendicular to the longitudinal directed of the screw.

Preferably, the cage may comprise two semi-cylindrical cage elements, a first semi-cylindrical cage element and a second semi-cylindrical cage element.

Each cage element may comprise one or more longitudinal placed cage elements. The one or more cage longitudinal placed elements may be placed in extension of each other along the longitudinal direction of the screw.

In an embodiment of the present invention the two semi-cylindrical cage elements, i.e. the first semi-cylindrical cage element and the second semi-cylindrical cage element, may extend through the cage of the screw press, in the longitudinal direction relative to the longitudinal direction of the screw, as a single longitudinal placed semi-cylindrical cage element; as 2 longitudinal placed semi-cylindrical cage elements; as 3 longitudinal placed semi-cylindrical cage elements; as 4 longitudinal placed semi-cylindrical cage elements; as 5 longitudinal placed semi-cylindrical cage elements; as 6 longitudinal placed semi-cylindrical cage elements; as 7 longitudinal placed semi-cylindrical cage elements or more.

Preferably, the first semi-cylindrical cage element and the second semi-cylindrical cage element, may extend through the cage of the screw press, in the longitudinal direction relative to the longitudinal direction of the screw, as a single longitudinal placed semi-cylindrical cage element.

In an embodiment of the present invention, the single longitudinal placed semi-cylindrical cage element may be a one-piece semi-cylindrical cage element.

A screw press may comprise a press chamber with a cage, comprising one or more longitudinal placed semi-cylindrical cage elements. longitudinal placed semi-cylindrical cage elements are considered relative to the longitudinal direction relative to the screw.

The press chamber comprising the screw and encircled by the cage may be supported by a supporting device, which supports the screw press to the floor. This construction may preferably be surrounded by or packed in a chassis.

In an embodiment of the present invention the cage may be provided with a multiplicity of inlays facing and fully surrounding the screw, whereby a press chamber may be formed within the cage, between the inlays and the screw.

The inlays may preferably be in contact with the inside of the cage elements facing the screw.

The screw press may be provided with one or more beams placed horizontally and parallel to the longitudinal direction of the screw.

The beams may be used for fastening the cage and/or the cage elements and/or for the attachment of the chassis.

A preferred embodiment of the present invention relates to a screw press comprising a press chamber comprising a screw and surrounded by a cage, wherein the screw comprising a shaft having a helical structure on the outside of the shaft, and wherein the cage is provided with at least two cage elements, wherein at least one cage element of the at least two cage elements comprises a pivotable connection allowing the at least one cage element to pivot, wherein a screw press is provided with at least 2 beams centrally placed above the press chamber.

The cage open assistant of the present invention may preferably be placed between the at least 2 beams. Preferably, the cage open assistant of the present invention may be centrally placed between the at least 2 beams.

Centrally placed between the at least two beams a one or more rails may be placed. The rail may comprise a waist, or the like, to support the rotating shaft, e.g. during removal of the rotating shaft.

During service or maintenance, a traditional procedure involves the disassembling of the screw press where individual sides of the chassis are removed and placed on the floor next to the screw press. Alternatively, an external cage open assistant is build on the outsideof the screw press which is removed after maintenance has finished. The semi-cylindrical cage elements are opened, so that, the press chamber and the screw become accessible. Following disassembly of one of the semi-cylindrical cage elements, the semi-cylindrical cage element is placed on the floor or opened by the external cage open assistant and the worn parts, like the inlays can be exchanged. New inlays may be inserted into the semi-cylindrical cage element. The semi-cylindrical cage element remained in the press chamber can either be provided with new inlays once the screw is removed from the press chamber, or it may be opened by also attaching a cage open assistant on the other side of the screw press to open the other semi-cylindrical cage element. Only when semi-cylindrical cage elements are exposed or opened, the associated inlays can be changed. Semi-cylindrical cage elements or the screw placed on the floor during maintenance, may be returned when re-assembling the screw press.

This indicates that maintenance and change of worn parts of semi-cylindrical elements, like worn inlays, is associated with high technical complexity and requires trained technical staff, because the disassembly and re-assembly of the screw press may be highly complex, time consuming and expensive.

This complexity may also cause the serviceability or flexibility in maintenance very limited, resulting in reduced performance of the screw press.

Since the accessibility of the cage and the inlays is difficult, a complex disassembly of many components must take place, e.g. to change worn inlays, maintenance and periodic maintenance must be performed by a skilled staff, often staff from the manufacturer, to ensure correct disassembly and re-assembly of the screw press, causing increased down time and increased costs involved with the maintenance of the screw press.

The inventors of the present invention surprisingly found that by providing at least one of the cage elements with a pivotable connection and a cage open assistant as described in the present invention, inspection and maintenance of the cage, inlays and the screw may be easy and quick, and resulting in an improved productivity.

Thus, the screw press, may comprise the semi-cylindrical cage elements pivotably mounted via a hinge allowing the semi-cylindrical cage elements to swing making the screw and the filtration space accessible, enabling a simpler and more rapid maintenance of the screw press and facilitate, in particular, the easy exchange of inlays.

In an embodiment of the present invention the hinge may in one end be attached to the second flange of one cage element and in the other end be attached to (i) the second flange of another cage element; or (ii) to a beam, preferably centrally located underneath the cage; or (iii) a bracket, preferably a bracket located below the cage.

Even maintenance may be performed faster and easier by implementing pivotable cage elements, the inventors found that handling of the pivotable cage elements may be difficult because of the weight of the pivotable cage elements and/or the restricted working conditions.

Therefore, the inventors of the present invention further found that working with the pivotably semi-cylindrical cage elements may be further improved by introducing an integrated cage opening assistant. This integrated cage opening assistant may assist in opening of the cage by handling and controlling the swing of the pivotably semi-cylindrical cage elements around the pivotably connection; it may secure the pivotably semi-cylindrical cage elements allowing free and safe working environment with the maintenance or the change of wear parts; and the cage opening assistant may assist in closing the cage by controlling the swing of the pivotably semi-cylindrical cage elements around the pivotably connection.

The use of a cage opening assistant may allow the use of pivotably semi-cylindrical elements having larger longitudinal sizes without it becomes unmanageable to the person performing the maintenance or changing the inlays. Thus, the cage opening assistant may make inspection and maintenance of the cage and the screw, as well as changing of inlays, even easier and quicker, even when working with large cage elements, and may reduce the risk of workers being injured, as the cage opening assistant may secure the pivotably semi-cylindrical elements.

By using the pivotably semi-cylindrical cage elements and the cage opening assistant disassembling of the screw press may be reduced or even avoided because the combination of pivotably semi-cylindrical cage elements and the cage opening assistant may opening of the vital parts of the screw press (rather than removing) providing easy and quick access to the essential parts of the screw press, in an easy, fast and safe way.

The term “pivotable connection” relates to a rod or point at which the at least two cage elements may be connected and allows the at least two cage elements of the cage may rotate or may swing. The connection of the at least two cage elements may be a direct connection between two cage elements or the connection of the at least two cage elements may be via a beam or a bracket both placed outside the cage and the beam being placed in parallel with the longitudinal direction of the screw, and wherein the bracket may be oriented transversely to the longitudinal direction of the screw.

The pivotable connection between at least two cage elements of the screw press may be provided by a pivoting device provided for holding together the at least two cage elements, such that one element can swing relative to the other.

In an embodiment of the present invention the pivotable connection may be provided with two interlocking leaves, preferably metal leaves, held together by a pin about which the leaves, and thus the cage element, are allowed to pivot or swing.

In a further embodiment of the present invention the cage comprising a perforated cage-wall.

The perforations provided in the cage-wall may preferably be provided as holes going through the cage-wall allowing a fat fraction or an oil fraction to leave the residual fraction obtained from pressing the material to be pressed.

The perforations provided in the cage-wall may also allow collection of the fat fraction or an oil fraction from the material to be pressed.

In an embodiment of the present invention the perforations provided in the cage-wall may be provided as elongated holes of the cage-wall.

The elongated holes may improve cleaning of the cage of the screw press improving the productivity of the screw press.

In an embodiment of the present invention the cage-wall may comprise a first flange and a second flange combined by curved ribs. The space between the curved ribs may form the elongated holes of the cage-wall.

The distance between the curved ribs may be in the range of 0.1-40 cm, such as in the range of 0.5-30 cm, e.g. in the range of 0.75-25 cm, such as in the range of 1-20 cm, e.g. in the range of 2-15 cm, such as in the range of 3-10 cm, e.g. in the range of 4-8 cm, such as 5-7 cm.

In an embodiment of the present invention the elongated holes of the cage-wall may extend from the first flange to the second flange.

In a further embodiment of the present invention the cage may be provided with a multiplicity of inlays on the inside of the cage.

The inside of the cage may be the space between the cage and the screw. Preferably, the inlays are placed in contact with the inside of the cage towards the screw.

The inlays may be placed perpendicular, or substantially perpendicular, to the direction of the ribs.

The inlays may in a first part of the press chamber only be placed in about the lower half of the press chamber. In the second part of the press chamber the inlays may be placed in the entire circumference of the inside of the cage elements.

In an embodiment of the present invention the first part of the press chamber may represent at most 3 times the distance from the beginning of the press chamber, taken from the starting material inlet, until the end of the starting material inlet, such as at most 2 times, e.g. at most 1 time. The second part of the press chamber may represent the remaining part of the press chamber, Preferably, about 1 time the distance from the beginning of the press chamber, taken from the starting material inlet, until the end of the starting material inlet.

The cage opening assistant may be an integrated part of the screw press. Preferably the cage opening assistant may be located inside a chassis of the screw press.

In an embodiment of the present invention the cage opening assistant may be fixed to at least one of the at least two cage elements.

In yet an embodiment of the present invention the cage opening assistant may be releasable attached to at least one of the at least two cage elements.

By being releasable attached it may be possible to attach one end of the cage opening assistant to the at least one of the at least two cage elements when the at least one of the at least two cage elements is to be opened to provide access to the press chamber and the screw.

In an embodiment of the present invention the cage opening assistant may be attached to at least one cage element.

Preferably, the cage open assistant may comprise a wire comprising a first end and a second end, wherein first end of the wire is connected to a winch; and wherein the second end of the wire is connected to a first fastening means.

In an embodiment of the present invention the cage open assistant comprises a wire comprising a first end and a second end.

Preferably, the first end of the wire may be connected to a winch.

Preferably, the second end of the wire may be connected to a first fastening means.

In an embodiment of the present invention, the first fastening means may be a hook, a carabiner or a shackle.

The cage elements may be provided with one or more second fastening means.

In an embodiment of the present invention the second fastening means may be placed on the second flange. Preferably, second fastening means may be placed on the upper most surface of the second flange of the cage element, before opening the cage.

In an embodiment of the present invention the second flange of the cage element may be located vertically, or substantially vertically, above the first flange of the cage element, when placed inside the screw press.

In an embodiment of the present invention, the second fastening means may be a ring; a carabiner; a shackle; or a hole made in the second flange of the cage element.

The first fastening means (e.g. provided as a hook, a carabiner or a shackle) may interact with and are fixed to the second fastening means (e.g. provided as a ring; a carabiner; a shackle; or a hole made in the second flange of the cage element).

In an embodiment of the present invention the cage open assistant may include a wire attached in one end to a winch which may be powered by an electrical motor, and in the other end of the wire a first fastening means (e.g. provided as a hook, a carabiner or a shackle) may be provided.

The inventors of the present invention found that one advantages of the present invention may be that the cage open assistant as described herein allowed the use of a single wire (including a single winch, a single electrical motor, and a single first fastening means (e.g. provided as a hook, a carabiner or a shackle) may be sufficient to handle (opening and closing) more than one cage element, e.g. both the semi-cylindrical cage elements, such as the first semi-cylindrical cage element and the second semi-cylindrical cage element.

The first fastening means (e.g. provided as a hook, a carabiner or a shackle) may be releasable attached to the second fastening means (e.g. provided as a ring; a carabiner; a shackle; or a hole made in the second flange of the cage element. are provided by means

By being releasable attached the first fastening means may only be attached to the second fastening means of the cage element when used and/or the first fastening means may initially be attached to one second fastening means of a first cage element and when the first cage element has been closed the first fastening means may be moved to the second fastening means of a second cage element. When the second cage element has been closed the first fastening means may be in a neutral position—where the first fastening means is not attached to any second fastening means.

In an embodiment of the present invention wherein the length of the wire (between the winch and the first fastening means) may be controlled by winding the wire onto the winch.

Preferably, the winch may be powered by an electric motor.

In an embodiment of the present invention the winch may be attached to the beam and/or bracket placed above the cage.

The winch may be attached to the beam and/or bracket placed above the cage but inside the chassis of the screw press.

In a preferred embodiment of the present invention the screw press comprises at least 2 beams above the press chamber. Preferably the at least 2 beams may be placed centrally over the screw press centre—the centreline of the cage.

A preferred embodiment of the present invention relates to the use of the screw press according to the present invention, for the separation of a liquid from a solid of a starting material.

The liquid removed may be an aqueous liquid, e.g. water, as it may be relevant to reduce the water content of a product before drying and because it may be desirable to collect the liquid material as a separate fraction as an added value product.

The liquid may also be an aqueous liquid comprising high value products, like proteins, enzymes, peptides, nucleotides, oligonucleotides or other relevant products.

The liquid may also be an oil or a fat product, where preferably a dried starting material may be subjected to pressing, resulting in a fat/oil fraction and a “de-fatted” solid fraction.

In an embodiment of the present invention wherein the starting material may be obtained from the rendering industry.

Rendering is a process that converts waste animal tissue into stable, usable materials and starting materials obtained from the rendering industry may refer to any processing of animal products into more useful materials, or, more narrowly, to the rendering of whole animal fatty tissue into purified fats like lard or tallow, or oils. The rendering industry relates to the industrial processing of animal or aquacultural waste products.

Even the present screw press may obviously be used with other starting materials, the invention is provided from the challenges and needs from the rendering industry, but the skilled person would easily understand how to apply the present invention with non-animal products.

In an embodiment of the present invention the starting material may be selected from feather, bone, meat, fish, larvae, and/or a plants (like soy, kokus, palm, nuts sunflower).

A preferred embodiment of the present invention relates to a method of inspecting the screw press according to the present invention, the method comprising the steps of:

(i) removing a first cassis side;

(ii) attaching a first fastening means of a cage open assistant to a second fastening means of a cage element;

(iii) activating the cage open assistant opening the cage element providing access to a press chamber and a screw of the screw press;

(iv) subjecting the cage to the required maintenance; and

(v) activating the cage open assistant and closing the cage element.

(vi) optionally, repeating steps (i)-(v) with a further cage element.

Preferably, the cage open assistant may be fully integrated into the screw press.

The cage open assistant may be fully integrated in the screw press and preferably, the cage open assistant may be fully integrated in the chassis of the screw press.

When activating the cage open assistant, the cage element may be opened or removed completely from the screw press.

In an embodiment of the present invention the cage open assistant may preferably be used for opening both sides of a cage comprising two cage elements. Thus, one cage open assistant is used for handling two (both) sides of the screw press and the cage elements.

It should be noted that embodiments and features described in the context of one of the aspects of the present invention also apply to the other aspects of the invention.

The invention will now be described in further details in the following non-limiting description of the figures.

### DETAILED DESCRIPTION OF THE FIGURES

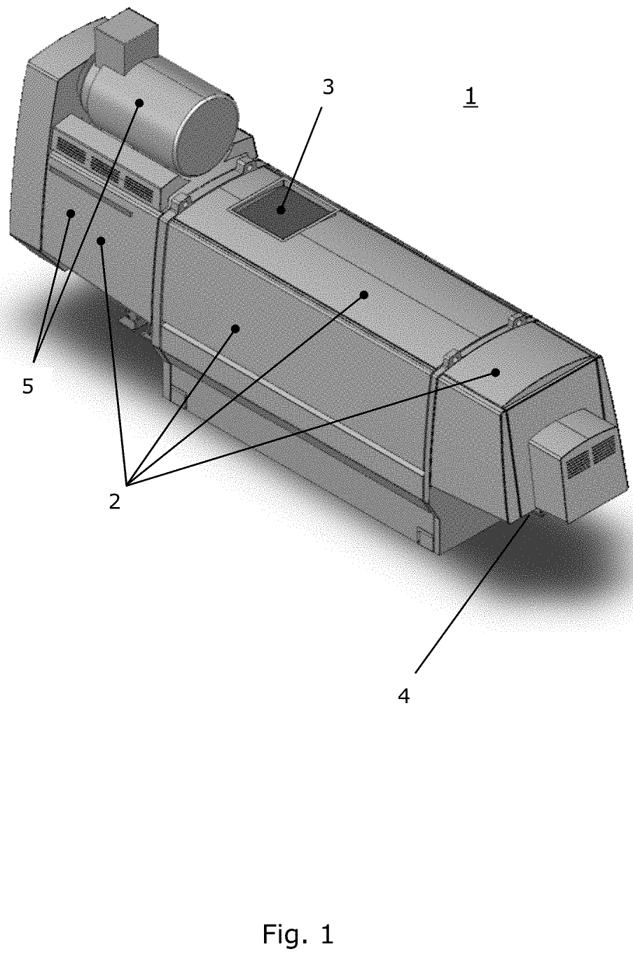

FIG. 1 describes a screw press (1) comprising a chassis (2) covering the screw press (1). On the top of the screw press (1) a starting material inlet (3) is provided where a starting material to be pressed may be introduced into the press chamber (not shown) of the screw press (1).

The starting material to be pressed may be any material from which a liquid material may be separated from a solid material. The liquid material may be an aqueous material, e.g. water, as it may be relevant to reduce the water content of a product before drying to reduce the energy consumption during drying or it may be desirable to collect the liquid material as a separate fraction as an added value product. Added value products may include isolated fractions comprising increased concentration of high value products, like proteins, enzymes, peptides, nucleotides, oligonucleotides or other relevant products. Other added value products of the liquid material may be an oil or a fat product, where the starting material preferably may be a dried starting material, which may be subjected to pressing, resulting in a fat/oil fraction and a “de-fatted” solid fraction.

Preferred starting material may be obtained from the rendering industry. Such material obtained from the rendering industry may be selected from feather, bone, meat, fish, larvae, and/or a plant (like soy, kokus, palm, nuts sunflower).

During operation the starting material may be introduced into the starting material inlet (3) and the starting material is transported through the press chamber of the screw press (not shown) towards the outlet of the solid material (4), by a rotating shaft (not shown) provided on the outside with a helical structure (not shown). The rotating shaft (not shown) may be powered by a driving unit (5), which may preferably include an electrical motor.

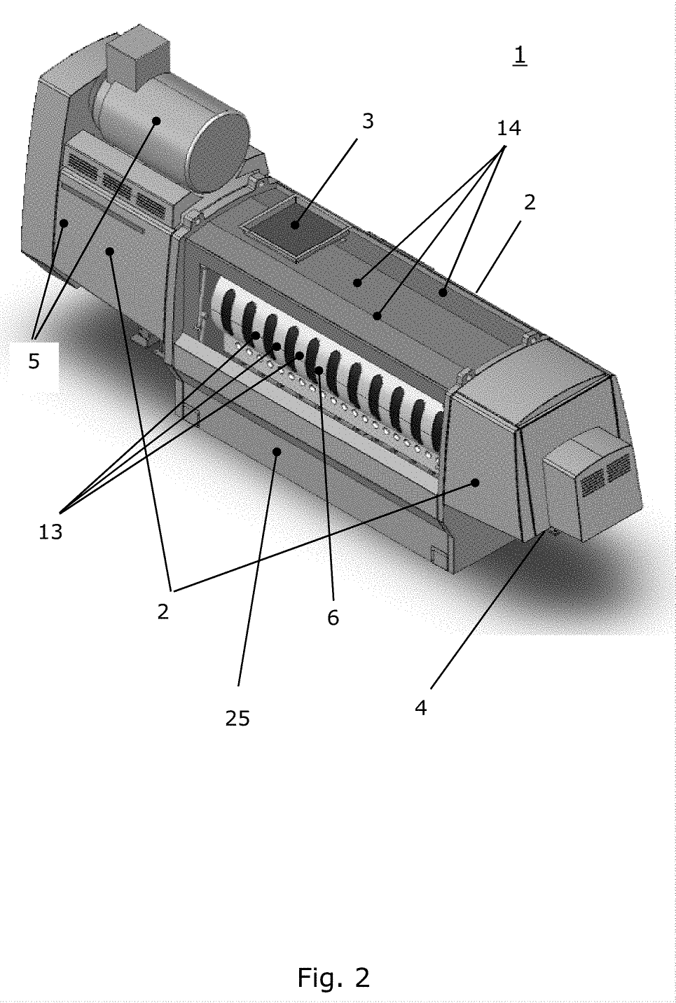

FIG. 2 describes the screw press (1) as described above regarding FIG. 1 where the chassis (2) covering the screw press (1) has been removed from the top of the screw press and from one side of the screw press. The screw press (1) of FIG. 2 shows a starting material inlet (3) provided for introduction of a starting material to be pressed into the press chamber (not shown) of the screw press (1).

FIG. 2 further show a support device (14) placed around a cage (6), which supporting device (14) may support the screw press (1) to the floor. This supporting device (14) may preferably be surrounded by or packed in a chassis (2). The supportive device (14) may comprise at least one upper beam (15—not shown in this figure) places on the inside of the supporting device (14)— preferably two upper beams, may be used to support the screw press (1) and may be centrally placed above the cage (6) along a centreline of the cage (6). The cage (6) encircles the press chamber (not shown) and the screw comprising the rotating shaft (9—not shown in this figure) having an outer surface formed with a helical structure (10—not shown in this figure). The cage (6) is provided with ribs (13), and the space between the ribs (13) provides an elongated hole of the cage-wall, allowing the liquid pressed from the starting material to filter through and into a collection tank (25) below the cage (6).

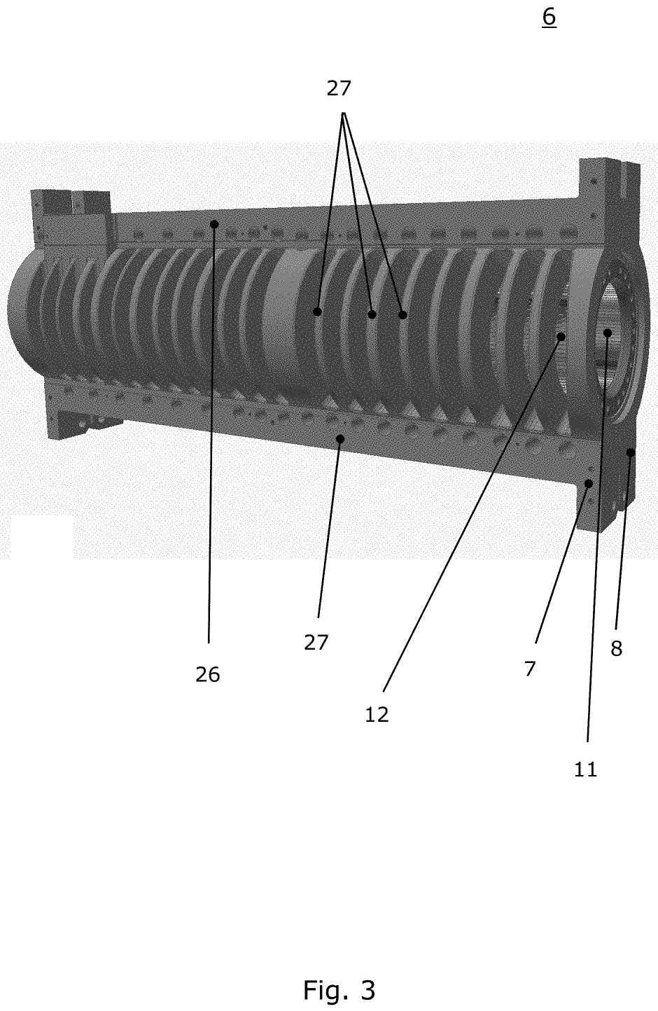

FIG. 3 shows a cage (6) comprising a first cage element (7) and a second cage element (8). The first cage element (7) and the second cage element (8) are fixed to each other and forms a press chamber (11). Each of the cage elements (the first cage element (7) and the second cage element (8)) comprise a first flange of the cage element (26) and a second flange of the cage element (27) which are connected via the ribs (13). The second flange (26) of the first cage element (7) and the second flange (26) of the second cage element (8) may be fixed together either directly to each other or indirectly, e.g. via a bracket (not shown). The first flange (27) of the first cage element (7) and the first flange (27) of the second cage element (8) may be fixed together either directly to each other or indirectly, e.g. via a hinge (not shown).

The cage (6) is on the inside of the first cage element (7) and the second cage element (8) provided with a multiplicity of inlays (12). The inlays (12) are placed with a small distance apart providing a small opening between the multiple inlays (12), preferably the opening between the inlays (12) may be less than 2 mm, such as less than 1.5 mm, e.g. less than 1 mm, such as less than 0.75 mm, e.g. less than 0.5 mm, such as less than 0.25 mm, e.g. less than 0.1 mm, such as less than 0.05 mm, e.g. less than 0.01 mm, such as less than 0.005 mm. This opening between the inlays (12) allows the liquid pressed from the starting material to pass but retaining the solid material and the fines in the press chamber.

The cage (6) in FIG. 3 comprises several ribs (13) where the space between the ribs (13) provides an elongated hole of the cage-wall, allowing the liquid pressed from the starting material through the multiplicity of inlays (12) as a filter through the cage (6) and into a collection tank (25—not shown in this figure) below the cage (6).

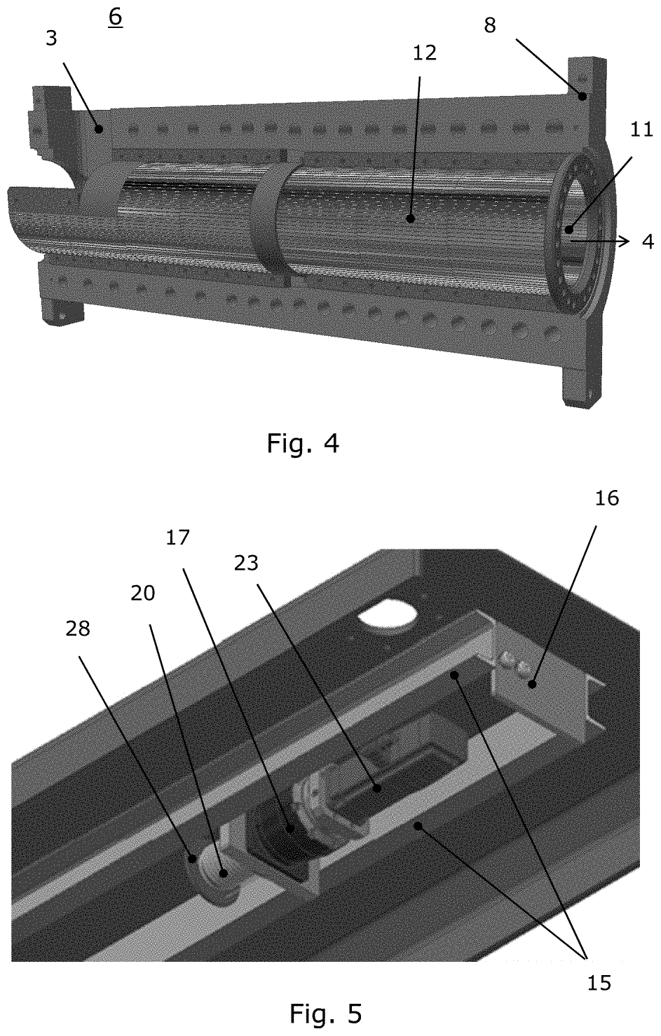

FIG. 4 also shows a cage (6) as described in above in respect of FIG. 3 and comprises a second cage element (8) but the first cage element (7—not shown in this figure) is removed to clearly illustrate the construction of the multiplicity of inlays (12) which goes along in the entire length of the press chamber (11) of the cage (6).

The inlays (12) in FIG. 4 are placed with a small distance apart providing a small opening between the multiple inlays (12), preferably the opening between the inlays (12) may be less than 2 mm, such as less than 1.5 mm, e.g. less than 1 mm, such as less than 0.75 mm, e.g. less than 0.5 mm, such as less than 0.25 mm, e.g. less than 0.1 mm, such as less than 0.05 mm, e.g. less than 0.01 mm, such as less than 0.005 mm. This opening between the inlays (12) allows the liquid pressed from the starting material to pass but retaining the solid material and the fines in the press chamber. The inlays (12) are in the first part of the press chamber (11) only placed in about the lower half of the press chamber. In the second part of the press chamber (11) the inlays (12) are in the entire circumference of the inside of the cage elements (7/8). Preferably, the first part of the press chamber (11) represents at most 3 times the distance from the beginning of the press chamber (11), taken from the starting material inlet (3), until the end of the starting material inlet (3), such as at most 2 times, e.g. at most 1 time. The second part of the press chamber (11) represents the remaining part of the press chamber (11), Preferably, about 1 time the distance from the beginning of the press chamber (11), taken from the starting material inlet (3), until the end of the starting material inlet (3).

At the starting material inlet (3) the inlays (12) may only be present at the lower half of the press chamber (11) since the pressure at this end lower allowing the liquid pressed from the starting material to pass at reduced pressure, even mainly by gravity, and the rotating shaft with the helical structure forces the starting material to be moved through the press chamber (11) increasing the pressure on the starting material as the starting material moves from the starting material inlet (3) to the outlet of the solid material (4).

FIG. 5 shows a cage open assistant (17) comprising a wire (20) powered by an electrical motor (23). The cage open assistant (17) may comprise a wire (20) comprising a first end and a second end, wherein first end of the wire (20) is connected to a winch (28); and wherein the second end of the wire is connected to a first fastening means (not shown in FIG. 5). The winch (28) may be attached to the beams (15) placed above the cage, alternatively or in addition the winch (28) may be attached to the bracket (16) placed above the cage (6—not shown in this figure). The winch (28) may be attached to the beams (15) and/or the bracket (16) inside the chassis (not shown in this figure) of the screw press (not shown in this figure), and thus, the cage open assistant (17) and the winch (28) may constitute an integrated part of the screw press.

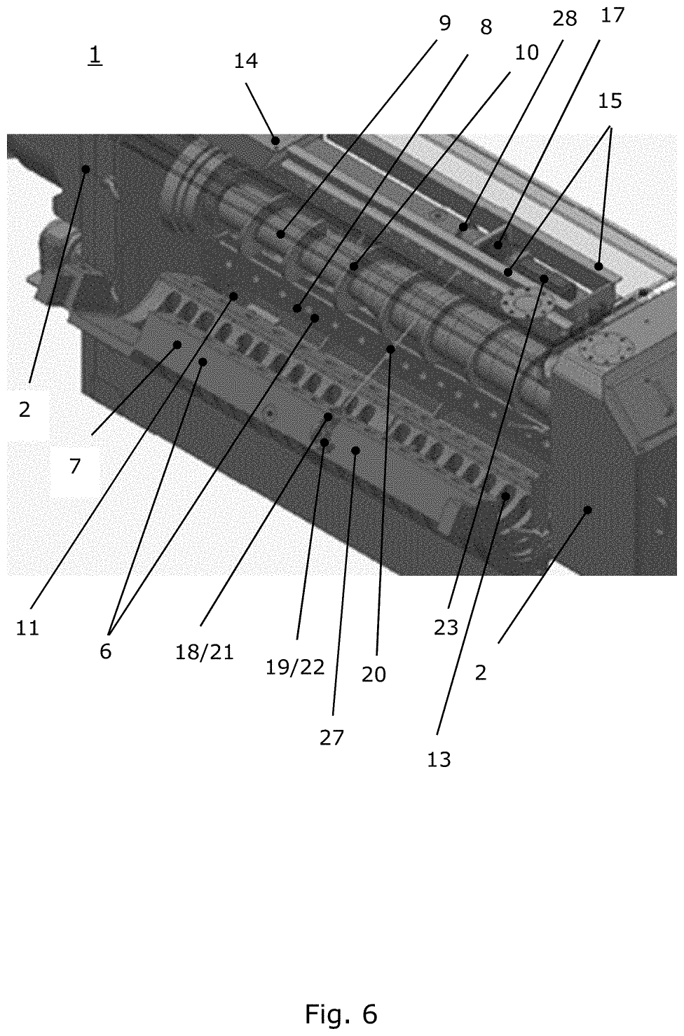

FIG. 6 shows a screw press (1) comprising a chassis (2) providing the outer shell of the screw press (1), where the chassis (2) has been removed from the top of the screw press and from one side of the screw press demonstrating a support device (14) placed around a cage (6), which supporting device may support the screw press (1) to the floor. This supporting device (14) may preferably be surrounded by or packed in the chassis (2). The supportive device (14) may comprise two upper beams (15), used to support the screw press (1).

Between the two beams (15) shown in FIG. 6 a cage open assistant (17) has been provided. The cage open assistant (17) comprising a wire (20) powered by an electrical motor (23). The cage open assistant (17) may comprise a wire (20) comprising a first end and a second end, wherein first end of the wire (20) is connected to a winch (28); and wherein the second end of the wire is connected to a first fastening means (18). The winch (28) may be attached to the beams (15) placed above the cage, alternatively or in addition the winch (28) may be attached to a bracket placed above the cage (6). The winch (28) may be attached to the beams (15) and/or the bracket inside the chassis (2) of the screw press (1), and thus, the cage open assistant (17) and the winch (28) may constitute an integrated part of the screw press. The first fastening means (18) may be provided as a hook (21) and the hook (21) may be attached to a second fastening means (19) provided in FIG. 6, in the form of a ring (22). The second fastening means (19) may be placed on the second flange of the cage element (27). Preferably, the second fastening means (19) may be placed on the upper most surface of the second flange of the cage element (27) and may be used for opening and closing the first cage element (7).

The first fastening means (18), e.g. provided as a hook, a carabiner or a shackle, may be releasable attached to the second fastening means (19), e.g. provided as a ring; a carabiner; a shackle; or a hole made in the second flange of the cage element. By being releasable attached the first attachment means (18) may initially be attached to the second fastening means (19) of a first cage element (7) and when the first cage element (7) has been closed the first fastening means (18) may be moved to the second fastening means (19) of a second cage element (8). When the second cage element (8) has been closed the first fastening means (18) may be in a neutral position—where the first fastening means (18) is not attached to any second fastening means (19).

The cage (6) encircles the press chamber (11) and the screw comprising the rotating shaft (9) having an outer surface formed with a helical structure (10). The cage (6) is provided with ribs (13), and the space between the ribs (13) provides an elongated hole of the cage-wall, allowing the liquid pressed from the starting material to filter through and into a collection tank (not shown in this figure) below the cage (6).

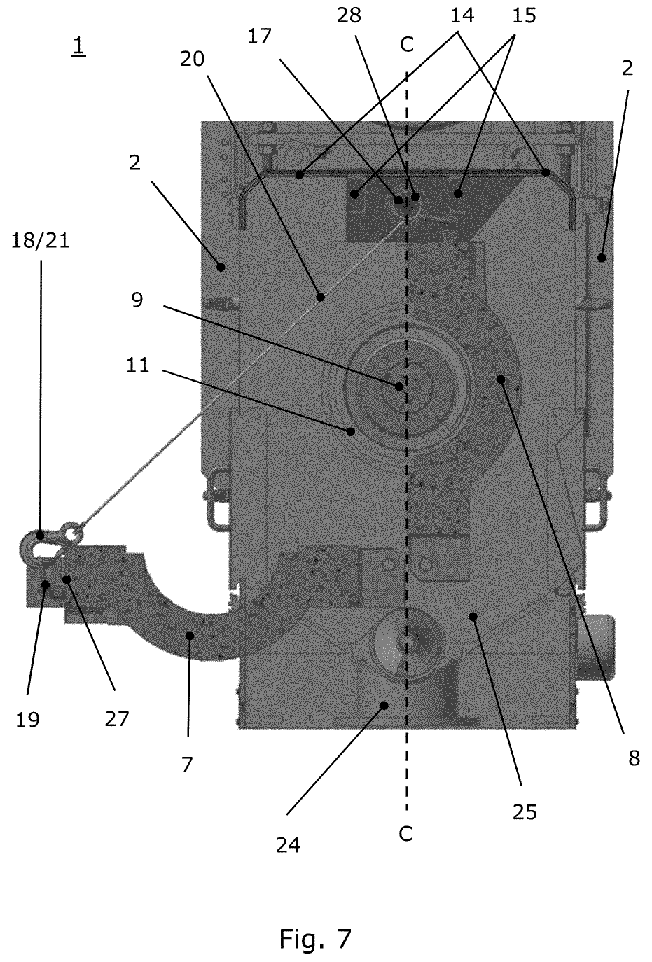

FIG. 7 show an end-view of the screw press (1) comprising a chassis (2). Underneath the chassis (2) a supporting device (14) comprising two beams (15) and a bracket may be provided. The two beams (15) are centrally placed above the press chamber (11) along a centreline (C) of the cage (and the rotating shaft (9). A cage open assistant (17) is provided between the two beams (15). The cage open assistant (17) comprises a wire (20) having in a first end connected to a winch (28) and a second end of the wire connected to a first fastening means (18), provided as a hook (21). The first fastening means (18) may be connected to a second fastening means (19) placed on the second flange of the cage element (27). Preferably, the second fastening means (19) may be placed on the upper most surface of the second flange of the cage element (27) and has been used for opening the first cage element (7) e.g. for maintenance. When the first cage element (7) has been closed the first fastening means (18) may be released from the second fastening means (19) of the first cage element (7) and attached to a second fastening means (19) on the second cage element (8), and the second cage element (8) may be opened and closed accordingly.

During operation the starting material pressed may excrete a liquid material, e.g. a fat or an oil, which may filter into the collection tank (25) below the cage (6) and to the outlet of the liquid (24).

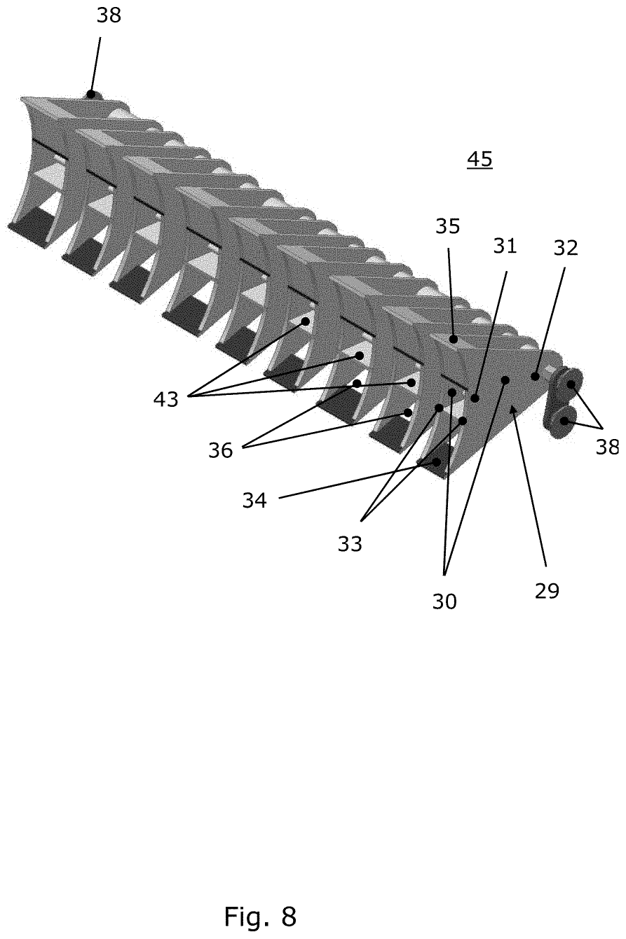

FIG. 8 show a cleaning device (45) according to the present invention. The cleaning device (45) comprises 9 corpus elements (29) which are configured to fit into the elongated holes between the ribs of a cage of a screw press (not shown in this figure). The corpus element (29) comprises two interconnected side surfaces (30) which may be made from a solid plate or a lattice. The two interconnected side surfaces (30) may comprise an open space (36) between the two interconnected side surfaces (30) allowing waste material cleaned to be escape. The two interconnected side surfaces (30) comprise a cleaning part (31) responsible for releasing and/or removing the waste materials from a surface and a connecting part (32) in the opposite end of the corpus element (29) and responsible for connecting the two interconnected side surfaces (30) as well as connecting the various corpus elements (29). The interconnected side surfaces (30) are, in addition to the connecting part (32), connected via a first-side (34) and a second-side (35). The first side (34) of the cleaning part (31) may be provided with a cutting element and the second side (35) of the cleaning part (31) may be provided with a scraping element, or vice versa, for assisting and improving the cleaning, e.g. of the outside of inlays of cage of a screw press. The first-side (34) and second-side (35), or the cutting element and the scraping element, may be connected via a curved structure (33) at the end of the cleaning part (31) of the two interconnected side surfaces (30) of each of the corpus elements (29). This curved structure (33) may be configured to provide a close interaction with the outer surface of the inlays of the cage of a screw press (not shown in this figure). The connecting part (32) of each of the 9 corpus elements (29) are combined via a drive arm (44) passing through the commenting part (32) of each of the 9 corpus elements (29). In the end of the drive arm (44) sliding elements (38) are provided to control the movement of the cleaning device when operated. The drive arm (44) is hexagonally shaped to assist movement and cleaning. The corpus elements (29) are also provided with a supporting member (43) extending from the curved structure (33) and into an open space (36) between the two interconnected side surfaces (30) to strengthen and stabilize the individual corpus elements during use.

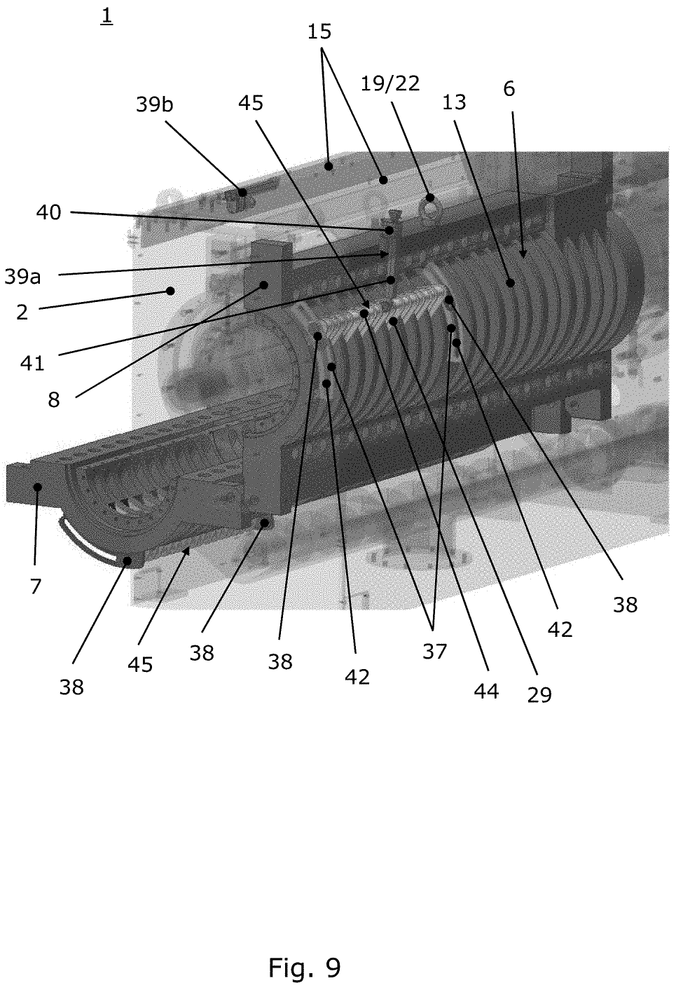

FIG. 9 show a screw press (1) comprising a chassis (2) providing an outer shell of the screw press (1), a supporting device (14) placed around a cage (6), which supporting device (14) may support the screw press (1) to the floor. This supporting device (14) may preferably be surrounded by or packed in the chassis (2). The supportive device (14) may comprise two upper beams (15) placed on the inside of the supporting device (14), and used to support the screw press (1).

The cage (6) comprises two cage elements, a first cage element (7) and a second cage element (8). The cage (6) is provided with ribs (13) and between the ribs (13) elongated holes are provided for receiving the corpus elements (29) of the cleaning device, cage cleaning device (45). The cage (6) has further been provided with a second fastening means (19) which in FIG. 9 is provided as a ring (22).

Both the first cage element (7) and a second cage element (8) provided in FIG. 9 comprises a cleaning device, a cage cleaning device, (45) comprising 9 corpus elements (29) which are configured to fit into the elongated holes between the ribs (13) of a cage (6) of a screw press (1). Each of the 9 corpus elements (29) are combined via a drive arm (44) passing through the commenting part of each of the 9 corpus elements (29). In the end of the drive arm (44) sliding elements (38) are provided, and the sliding elements (38) are movably mounted in sliding rails (37) on the cage (6) to control the movement of the cleaning device (45) when operated.

Movement of the cleaning devices, the cage cleaning devices, (45) may be controlled by an actuator (39) comprising a stationary end (40) attached to the supporting device (14) and a movable end (41) attached to the drive arm (44) of the cleaning device, the cage cleaning device, (45), where the sliding elements (38) on the drive arm (44) moves in the elongated slots (42) of the sliding rails (37), and moving the cleaning device, the cage cleaning device, (45) along the outer surface of the inlays (not shown in this figure).

FIG. 9 shows a closed second cage element (8) where the cleaning device (45) are coupled to the movable end (41) of the actuator (39a) and the stationary end (40) attached to the supporting device (not shown in this figure). FIG. 9 also show an opened first cage element (7) where the cleaning device (45) are uncoupled from the movable end (41) of the actuator (39b) and the stationary end (40) attached to the supporting device (not shown in this figure) has been rotated relative to the coupled position the actuator, hence allowing improved access to the inside of the cage and the press chamber.

It should be noted that embodiments and features described in the context of one of the aspects of the present invention also apply to the other aspects of the invention.

### REFERENCES

(1): screw press
(2): chassis of the screw press
(3): starting material inlet
(4): outlet of solid material
(5): driving unit
(6): cage
(7): first cage element
(8): second cage element
(9): rotating shaft
(10): helical structure
(11): press chamber
(12): inlays
(13): ribs
(14): supporting device
(15): beam
(16): bracket
(17): cage open assistant
(18): first fastening means
(19): second fastening means
(20): wire
(21): hook
(22): ring
(23): electrical motor
(24): outlet of the liquid
(25): collection tank
(26): first flange of the cage element
(27): second flange of the cage element
(28): winch
(29): corpus element
(30): interconnected side surfaces
(31): cleaning part
(32): connecting part
(33): curved structure
(34): first side
(35): second side
(36): open space
(37): sliding rails
(38): sliding elements
(39): actuator
(40): stationary end
(41): movable end
(42): elongated slot
(43): supporting member
(44): drive arm
(45): cleaning device; cage cleaning device

1. A cleaning device (45) comprising at least two corpus elements (29), the corpus element (29) comprises two interconnected side surfaces (30), the two interconnected side surfaces (30) comprises a cleaning part (31) and a connecting part (32) for connecting the at least two corpus elements (29), wherein the cleaning part (31) comprises a curved structure (33) extending from a first-side (34) to a second-side (35) of the cleaning part (31).

2. The cleaning device (45) according to claim 1, wherein the two interconnected side surfaces (30) comprise a solid plate or a lattice.

3. The cleaning device (45) according to claim 1, wherein the two interconnected side surfaces (30) are made by a metal material, a ceramic material, or a plastic material.

4. The cleaning device according to claim 1, wherein the space between the two interconnected side surfaces (30) is an open space (36).

5. The cleaning device according to claim 1, wherein the cleaning part comprises a cutting element (34) and/or a scraping element (35).

6. A screw press (1) comprising a press chamber (11) comprising a rotating shaft (9) and surrounded by a cage (6), wherein the rotating shaft (11) having a helical structure (10) on the outside of the rotating shaft (11), and wherein the cage (6) is provided with at least two cage elements, the cage (6) is provided with a cleaning device (45) according to claim 1.

7. The screw press (1) according to claim 6, wherein movement of the cleaning device (45) is controlled by an actuator (39).

8. The screw press (1) according to claim 6, wherein the cleaning device (45) comprises at least two sliding elements (38) which are movable connected with at least at least two sliding rails (37) provided on the cage (6).

9. The screw press (1) according to claim 6, wherein the cleaning device (45) is integrated into the screw press (1), in particular in the chassis (2) of the screw press.

10. A method of removing solid material from the surface of a cage (6) and/or one or more inlays (12) of a screw press (1) by using the cleaning device (45) according to claim 1.
